(19) United States
(12) Patent Application Publication
(10) Pub. No.: US 2012/0123948 A1
(43) Pub. Date: May 17, 2012

(54) Judging Methods And Systems

(76) Inventors: Rachel Fefer, Barbereche (CH); Sally Fonner, Barbereche (CH)

(21) Appl. No.: 12/944,826

(22) Filed: Nov. 12, 2010

(51) Int. Cl. G06Q 10/00; G06Q 50/00

(52) U.S. Cl. 705/301; 705/321

(57) ABSTRACT

An approach to judging contests, competitions, and events in which aspects of crowdsourcing are applied to the judging, so that skill and/or talent and/or merit will predominate the voting outcomes rather than chance when using non-expert demographically diverse voters as judges. A contest, competition, or event judging method includes: accepting applications from potential web based non-expert judges (WebNEV) by establishing the unique identity thereof to yield a population of potential WebNEVs; assessing attributes of each potential WebNEV; collecting and analyzing information about the reasons each potential WebNEV wants to judge the contest, competition, or event; and selecting and registering WebNEVs from the population of potential WebNEVs, the selected WebNEVs being those that as a group which maximizes demographic diversity while balancing bias in accordance with the contest's, competition's, or event's rubric.

### BACKGROUND

1. Technical Field

Embodiments of the present invention relate generally to contest, competition, and event judging and, more particularly, to crowdsourcing judging where merit, talent and/or skill will predominate over chance when using non-expert demographically diverse voters to determine the outcome.

2. Description of Related Art

The importance of collective intelligence without regard to recognized expertise has been a phenomenon since the early twentieth century. In recent years, technological advances combined with broad acceptance of the Internet have made this phenomenon more acceptable and an increasingly influential factor in the competitive reputation global economy.

Contests in which participants compete in skill or talent rankings have long been popular, and the winners are ultimately decided by the selected judging population who are designated as experts. Contests that include fees and award prizes which are predominated by chance, subject to manipulation or prizes are related to the number of participants are all subject to state and federal gaming laws regardless of the voting methods, the competition environment and/or the source of the voters. For competitions taking participant fees and predominated by chance there are a multitude of methods and systems for determining the outcome. Historically, fee based merit, talent and/or skill competitions whose outcome is determined by non-expert voters from the crowd have not existed.

Crowdsourcing, a term coined by Jeff Howe in June, 2006 to illustrate the harnessing of collective intelligence through the Internet to accomplish tasks with the aim of a better outcome, has proven its validity in numerous settings. One setting where crowdsourcing has not been, however, is in competitive judging where the outcomes cannot be left to chance or popularity.

All methods and systems, regardless of the level of technology employed for deciding the outcome, involving merit/skill/talent competitions that seek to include the crowd vote ultimately place the final decision in the hands of an individual or individuals that are considered experts within the relevant industry. If there is a fee involved, then the non-expert vote or the crowd vote is not used for elimination but as part of the knowledge base that contributes to the expert's ability to make a decision.

The individual expert's decision is transparent only when the judging rubric requires scoring to be tied to a particular judge in a public manner. The extent of the information available about a judge varies greatly from contest to contest and judge to judge.

The diversity of the crowd is recognized to be the pivotal element in the efficacy of crowdsourcing and the rationale for why the crowd outperforms a body of experts in finding a solution. Smartsourcing, a recent term coined (2009) by Pete Peterson and applauded by Howe, refers to the need to incorporate a “crowd of models” from Scott E. Page's work (2007) in collective intelligence.

There are numerous metrics to measure the success of a contest.

One success metric is both the spectators' and the competitors' trust in the outcome. Trust is directly related to the propriety and fairness of the competition. Often, however, due to the complexities in the establishment and administration of a contest, it may be difficult to effectively communicate the judging process to participants, which may reduce confidence in the fairness of the contest. This, in turn, may lower participant trust and thus future participation.

In recent years, personal computers of ever-increasing computational power have become more and more affordable with network connectivity and available bandwidth between computers greatly increasing and facilitating the use of the collective consciousness through crowdsourcing. As a result, people all over the globe are encouraged to make comments and cast votes on a variety of subjects through various rating systems. In particular when it is a contest, the outcome is particularly susceptible to questions about the fairness in the way the contest is administered/conducted. Indeed, because of their electronic nature, it may be difficult to verify, for example, that each judge is unique (i.e., one vote each), that they are who they say they are, and that their individual vote is not part of a larger agenda that would dominate over the merit, talent and/or skill competition and the contest's rubric. So, for example, you have 100 people voting and you can prove they are unique but you can't provide any evidence that 80 of them did not all go to the same high school and that correlates with why they all voted for the contestant from their high school. This is an excellent example of how bias contributes to chance.

Also, in recent years, there has been an increase in hybrid contests, such as the television program American Idol, in which votes may be registered personally (by telephone) or impersonally (over the Internet). These types of contests are particularly susceptible to questions of fairness and accuracy since they often permit voting without regard to whether the voter is qualified to vote or has voted more than one time. Consequently, contests such as these are susceptible to suspicions as to the reasons that produced the winners.

### BRIEF SUMMARY

According to an aspect of the present invention, there is provided a method of creating a diverse population of judges. The method includes: generating a population of potential web based non-expert judges (WebNEVs) by establishing the unique identity of each WebNEV, which creates a WebNEV application for the respective potential WebNEVs; assessing attributes of each potential WebNEV, the attributes being usable (i) to determine which type of contest the WebNEV would be suitable to judge and (ii) to determine and/or increase the degree of demographic diversity within the judging body; collecting and analyzing information about the reasons each potential WebNEV wants to judge the contest, the information being usable to determine whether the prospective WebNEV could be a satisfactory judge for a contest; registering the accepted application as registered WebNEVs; and selecting a sub-population of WebNEVs from the population of registered WebNEVs, the selected sub-population consisting of WebNEVs who, as a group, can best judge the contest's entries based on the design of the contest. At least one of the converting, assessing, collecting, and selecting is performed by a computer.

According to an aspect of the present invention, there is provided a contest, competition, or event judging method. The method includes: accepting applications from potential web based non-expert judges (WebNEV) by establishing the unique identity thereof to yield a population of potential WebNEVs; assessing attributes of each potential WebNEV; collecting and analyzing information about the reasons each potential WebNEV wants to judge the contest, competition, or event; and selecting and registering WebNEVs from the population of potential WebNEVs, the selected WebNEVs being those that as a group which maximizes demographic diversity while balancing bias in accordance with the contest's, competition's, or event's rubric. At least one of the registering, assessing, collecting, and selecting is performed by a computer.

According to still another aspect of the present invention, there is provided a method of creating and presenting a diverse pool of questions and various modes of presentation for answering usable in the building of a pool of questions to be asked by those selected to judge a wide range of competitions. The method includes: soliciting basic questions from its own database or additional sources to be voted on by various crowdsourcing techniques in order of perceived importance; testing different presentation mode of questions to eliminate discrepancies and bias; presenting three times a number of required questions with respective rankings, which are determined to be most relevant, to a contest's task force for final selection; permitting the contest's administrator to select final questions in accordance with the contest's rubric; presenting the questions as encoded to all WebNEVs in the manner selected by the administrator; providing the outcomes in a number of formats to the task force on both a scheduled and on-demand basis; performing on-going statistical evaluations to monitor for any anomalies in voting trends; and monitoring and evaluating, using sentiment monitoring tools for comments and network buzz as a base evaluation against the voting results, a level of congruency between feedback mediums with voting results of the method as both a means to monitor voting behavior and improve the questions and presentation methods. At least one of the soliciting, testing, presenting three time a number of required questions, permitting, presenting the questions, providing, performing, and monitoring is performed by a computer.

According to yet another aspect of the present invention, there is provided a method of conducting a contest, competition, and/or event. The method includes: certifying selected questions to confirm that they are within the contest's/competition's/event's judging rubric; certifying each participating registered web based non-expert judge (WebNEV) of a selected population of WebNEVs based on WebNEV identity and confirmation of approval to judge the contest/competition/event; presenting each contestant's entry or entries in a manner consistent with the contest's rubric to the selected population of WebNEVs; executing judging activity by asking of the certified WebNEV(s) a discrete series of questions pertaining to each entry requiring answers in different response modes to yield judging results; timing the judging activity to ensure that a specified elimination level requirement is satisfied; reviewing the judging results of the executed judging activity; and collecting, analyzing, and reporting judging results. At least one of the operations is performed by a computer.

Still other aspects of the present invention provide tangible computer-readable storage media encoded with processing instructions for causing a processor to execute the aforementioned methods.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1. is a flowchart of a method of creating a diverse population of judges consistent with an embodiment of the present invention;

FIG. 2. is a flowchart of a method of creating and presenting a diverse pool of questions and various modes of presentation for answering usable in the building of a pool of questions to be asked by those selected to judge a wide range of competitions consistent with an embodiment of the present invention; and

FIG. 3 is a method of conducting a contest, competition, and/or event consistent with an embodiment of the present invention.

### DETAILED DESCRIPTION

Reference will now be made in detail to embodiment(s) of the present invention, examples of which is/are illustrated in the accompanying drawings, wherein like reference numerals refer to the like elements throughout. The embodiment(s) is/are described below to explain the present invention by referring to the figures.

In the description that follows, aspects of the present invention are discussed in the context of an Internet contest. It is to be understood, however, that aspects of the present invention are applicable to other types of contests, competitions, and or events. One non-limiting example is a political race.

In the description that follows, three aspects of an approach to conducting competitions are discussed. These aspects further objectives of the present invention to ensure diversity in a judging pool and the predominance of merit, talent and/or skill over chance.

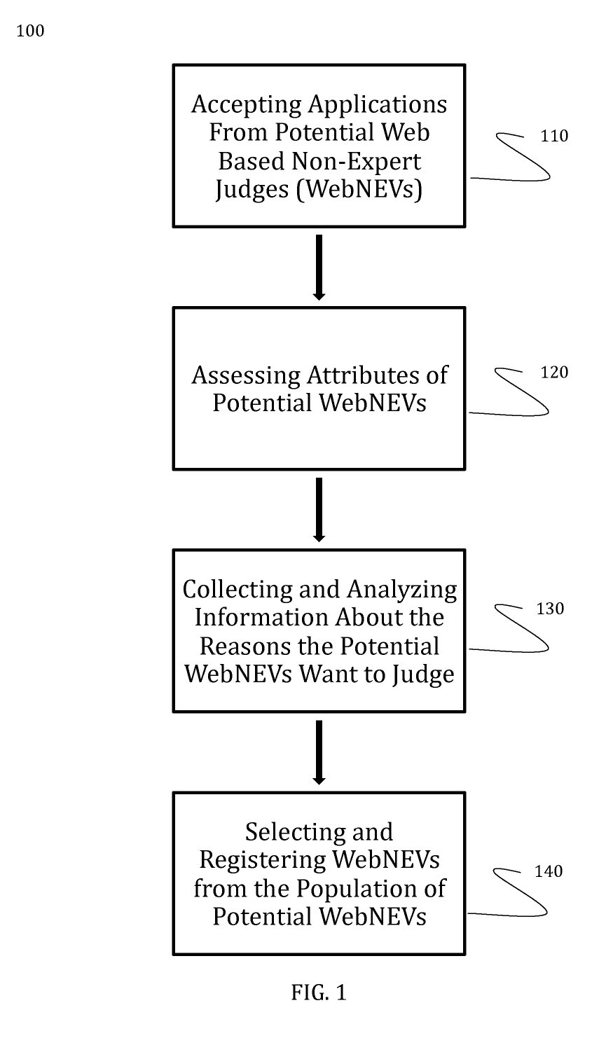

Referring to FIG. 1, there is illustrated a method 100 of creating a pool of judges consistent with an embodiment of the present invention. The method 100 includes the following operations: accepting applications from potential web based non-expert judges (WebNEVs) (operation 110); assessing attributes of the potential WebNEVs (operation 120); collecting and analyzing information about the reasons the potential WebNEVs want to judge a particular contest/event (operation 130); and registering WebNEVs from the population of potential WebNEVs for a contest based on contest/event design (i.e., selecting WebNEVs that as a group can best judge the contest's/event's entries) (operation 140). Each operation is discussed in turn.

In operation 110, the unique identity of each potential WebNEV is established through unique identification and confirmation. Optionally, the WebNEVs may be culled only from visitors to a specified website site who chose to participate in deciding a contest outcome, and/or whose identities were confirmed by third parties. It is to be understood, however that the method can draw WebNEVs from any population, including, for example, an administrator/creator/promoter's own employees and would confirm identities through the contest administrator/creator/promoter's own sources as long as WebNEVs voting were demographically diverse rather than homogenized group driven by affiliation, loyalties or labels rather than affinity. By this operation, a plurality of judge candidates is converted into a population of potential web based non-expert judges (WebNEVs) by establishing the unique identity of each WebNEV, which renders the individual a potential WebNEV. Examples of questions that may be presented to prospective WebNEVs in this operation are presented in TABLE 1 below. After the basic questions are answered, the prospective WebNEV will be given impetus, personality, and demographics questions, as discussed below. Following completion of those steps, the prospective WebNEV will be asked for information (in a secure environment) that will allow for third-party confirmation of their identity (i.e. Social Security Number) and will also allow for payment arrangements to be put in place.

TABLE 1

| | |
|---|---|
| 1. | What is your name? |
| 2. | What is your address? |
| 3. | How long have you lived at that address? |
| 4. | What is your telephone number? |
| 5. | What is your email address? |

The establishing of the unique identity for each WebNEV in operation 110 ensures that each WebNEV casts only one vote for each item of contest content reviewed. This prevents judges from manipulating contests by voting multiple times and provides transparency in the judging process. In this way, the method promotes merit/talent and/or skill over chance by ensuring the transparency of the judging outcome.

Next, in operation 120, the attributes and demographics of each potential WebNEV are assessed. Here, attributes are usable to determine which type of contest(s) the WebNEV would be suitable to judge. Also, the attributes are usable to project the degree of demographic diversity within a selected sub-population of registered WebNEVs, as is explained below. This assessment may be accomplished by, for example, personality tests, life knowledge/experience tests, and informational demographics. This information may be amalgamated for in-depth profiling. Here, various testing protocols and technology provide the most in-depth profiling when combined with demographic considerations. Additionally and/or alternatively, so-called “off-the-shelf” personality and life tests may be used and basic demographics may be collected. Examples of personality questions that may be presented to potential WebNEVs in this operation are presented in TABLE 2 below. Answers to these questions may facilitate placement of prospective WebNEVs into one of 16 personality types (based on the Jungian and Briggs-Myers personality models).

TABLE 2

| | | | |
|---|---|---|---|
| 1. | You are almost never late for your appointments | Yes | No |
| 2. | You like to be engaged in an active and fast-paced job | Yes | No |
| 3. | You enjoy having a wide circle of acquaintances | Yes | No |
| 4. | You feel involved when watching TV soaps | Yes | No |
| 5. | You are usually the first to react to a sudden event: | Yes | No |
| | the telephone ringing or unexpected question | | |
| 6. | You are more interested in a general idea than in the | Yes | No |
| | details of its realization | | |

This assessment creates a means to select a pool/population of non-expert judges to judge a contest within a specified contest rubric while further ensuring that each judge casts only one vote for each contest entry reviewed. This ensures that the overall voting is balanced and is from a diverse pool. Examples of demographics questions that may be presented to potential WebNEVs in this operation are presented in TABLE 3 below. Answers to these questions will help the WebNEV selection process in the area of balancing bias and creating a diverse judging group.

TABLE 3

| | |
|---|---|
| 1. | How many siblings did you grow up with? |
| 2. | Where do you rank within that group - youngest, middle, oldest? |
| 3. | Where did you grow up? |
| 4. | Today, do you consider yourself a Southerner, Midwesterner, |
| | East Coaster, West Coaster? |
| 5. | Do you work: A) In an office; B) Outdoors; C) At home; and |
| | D) On the road? |
| 6. | What is your educational level - GED, high school graduate, |
| | college graduate, graduate school, post-graduate studies, other? |
| 7. | Which of the different technology mediums do you have regular |
| | access to: A) Mobile telephone; B) Computer; C) Broadband; |
| | and D) Some type of video game system |

In this operation, elevating predominance of merit, talent and/or skill over chance and providing a transparent outcome is achieved by balancing the selected WebNEV attributes and demographics.

In operation 130, the impetus for each potential WebNEV to be a judge is assessed. This information is usable to increase the work satisfaction of a WebNEV. Examples that affect work satisfaction would include time demands, compensation modes, compensation amounts and feedback models. Such information may be collected either through questionnaires and interviews or a combination for the two on a regular and cumulative basis. Additionally and/or alternatively, initial compensation would be established from the intake answers with no on-going analysis. Examples of questions probing a potential WebNEV's reasons for wanting to judge are presented in TABLE 4 below.

TABLE 4

| | Why do you want to be a WebNEV? Check all that apply. |
|---|---|
| 1. | I need to work from home. |
| 2. | I need to supplement my income. |
| 3. | I want to earn virtual currency. |
| 4. | I know a lot about different talent areas. |
| 5. | I enjoy Internet activities of all kinds. |

This method analyzes the answers given by each potential WebNEV to provide a relative scale of distinct compensation for each WebNEV to maximize the WebNEV's desire to continue judging. For example, a WebNEV whose primary reason for judging was to earn virtual currency to spend in virtual transactions could elect payment from various virtual options rather than receiving cash. Additionally and/or alternatively, available compensation alternatives for the level of judging each registered WebNEV requests or seeks to reach without on-going analysis of compensation in relationship to judging levels and requirements may be offered. Under this scenario, they would only have one opportunity to choose the type of compensation to be received.

This operation promotes WebNEV job satisfaction. It has been shown that the higher the level of perceived value both given and received in an activity the more often the activity will be repeated and “owned”—resulting in the WebNEVs' desire to improve the final work product. Thus, this operation lays the foundation for creating individualized compensation and work environments that best suit the individual and lead to the improvement of the judging process. In more detail, this operation provides the WebNEVs with the desired compensation in order to create a strong and growing pool of WebNEVs. This is important because the larger the pool of WebNEVs, the greater the diversity to choose for a particular event, thus minimizing bias and the element of chance.

Next, in operation 140, WebNEVs are registered—WebNEVs are selected from the population of potential WebNEVs so that, as a group, they can best judge the contest's entries based on a specified contest rubric without bias. Stated another way, a sub-population of WebNEVs from the population of potential WebNEVs is selected, the selected sub-population consisting of WebNEVs who, as a group, can best judge the contest's entries based on a design of the contest. To this end, the registered WebNEVs are selected so that demographic diversity is maximized while contemporaneously balancing bias according to a contest's rubric. The number and the selection of WebNEVs required for each round of a contest may be dictated by the contest's rubric. In this way, a population of registered WebNEVs is segmented based on the contest's rubric.

Here, a contest's entry requirement(s) may be analyzed along with its judging rules to select WebNEVs in a manner consistent with providing a fair judging environment. Additionally and/or alternatively, the selection may be based not solely on the rubric of the contest but instead on the contest creator/promoter's answers to specific questions about the contest and descriptions of the qualities on which to base the selection of the WebNEVs for the contest. Here, software may scan for potential bias creation or inappropriate quality selection choices and report them to the contest administrator but not make the changes automatically.

As a result of the selecting in operation 140, the balance of a judging environment is increased, which minimizes the element of chance. This diversity in the judging pool, in turn, promotes the predominance of merit, talent and/or skill over chance.

All of the above operations interact to yield a protocol (judging protocol of Internet non-expert voters (JPINEV)) registration for having non-expert voters judge contests in which the entries are user generated content in a non-biased environment where merit, talent and/or skill predominates over chance. The first operation, identification of each potential judge, combats any illegal ballot casting but does not, on its own, ensure the predominance of merit, talent and/or skill nor provide a means by which the contest can be judged on the basis of its stated rubric. Thereafter, various other operations increase the transparency of the voting process and give an understanding of the voting pool's dynamics while at the same time ensuring that each entry is judged on the same criteria. The key to facilitating the quality of the judging process goes beyond the mechanics and extends to the desire of the judging body to perform its task in the best manner to achieve a trustworthy and community-valued outcome.

Any of operations 110-140 of method 100 may be executed by a specified machine adapted to realize the method.

The categories of questions types, question modes, and question sources are discussed. Generally, there are five different categories of question types and presentable to the WebNEV's with questions formatted in one or more of these categories:

Factual questions—these solicit simple, straightforward answers based on obvious facts or awareness. (Ex. In an opera contest, we would ask the WebNEVs whether they could understand the lyrics.)

Convergent—these types of questions require answers that are usually within a very finite range of acceptable accuracy. These may be at several different levels of cognition—comprehension, application, analysis, or ones where the answerer makes inferences or conjectures based on personal awareness, or on material read, presented or known. (Ex. In an opera contest, we would ask the WebNEVs whether, after viewing the contest entry, they believed the singer conveyed the proper emotional range during the performance.)

Divergent—these questions allow for the exploration of different avenues and may create many different variations and alternative answers. Correctness may be based on logical projections, may be contextual, or arrived at through basic knowledge, conjecture, inference, projection, creation, intuition, or imagination. These types of questions often require one to analyze, synthesize, or evaluate a knowledge base and then project or predict different outcomes.

Evaluative—These types of questions usually require sophisticated levels of cognitive and/or emotional judgment. In attempting to answer evaluative questions, answers may require a combination of multiple logical and/or affective thinking process, or comparative frameworks. Often an answer is analyzed at multiple levels and from different perspectives before the answerer arrives at newly synthesized information or conclusions.

Combinations—These are questions that combine one or more of the above question formats.

The manner in which a question is asked may have significant impact on the answer. The decision of which mode to use is dependent on a variety of factors: understanding level, brain formatting, personal demographics and general life experience. The JPINEV's internal feedback will increasingly be able to design the best question mode for each WebNEV based on the different question genres. Therefore, all of the questions asked of the WebNEVs will be designed in several formats. The formats will be presented either in visual, written, audio or a combination of two or more such formats. The question mode paradigms will become more complex as the WebNEVs seek certification in different judging arenas. So, for example, the WebNEV who is only judging a single level contest in one talent area for six months will have answered far less questions in general but may have answered the same question genre presented in different modes.

An example of a visual question for personality testing would be showing different faces and asking them to choose from a list of emotions. The results would then be compared to known responses and standard psychology evaluations.

Whether it is questions for WebNEV registering and/or certifying or contest questions, the source of questions will start from recognized sources and then evolve as the JPINEV environment grows and provides an adequate environment for analysis and change based on the results of statistical applications. In addition, questions may be rated by crowdsourcing as to relevance and importance. For example, in the beginning, testing during the registration of a WebNEV may use recognized testing protocols with their results being compared to their normal databases. As our internal databases grow then the JPINEV database may be incorporated to better understand the different testing modalities and paradigms to provide continual evaluation of the process against JPINEV's goals. The same is equally true of contest questions. Every talent area has a wealth of accessible information from a myriad of sources. As an example, in order to craft questions for a Opera contest seeking a dramatic mezzo voice type, often used to portray older women, mothers, witches and evil characters, we would access the various Opera sites seeking out descriptions, examples and comments about this voice type. From here we would create questions that were specific to the voice type but important to the overall talent. The questions then would be road tested within audiences of varying depths of expertise.

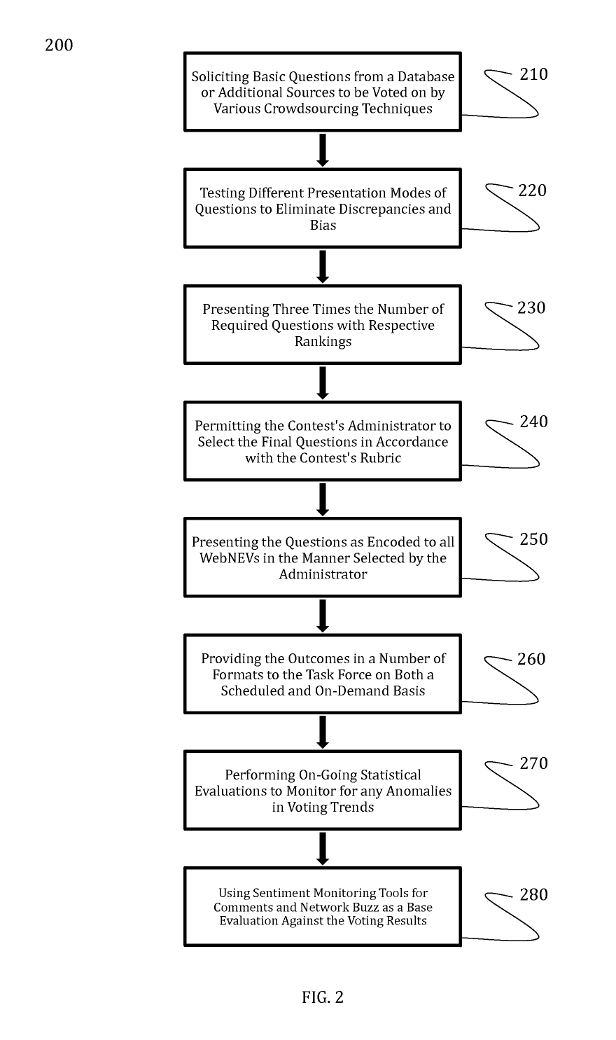

Referring now to FIG. 2, there is illustrated a method 200 of method of creating and presenting a diverse pool of questions and various modes of presentation for answering usable in the building of a pool of questions to be asked by those selected to judge a wide range of competitions. These questions are created from multi-facet sources presented in different mediums congruent with the contest's rubric and reflective of the crowd ranking judgment.

As is known in the art, questions for contests are generally derived from experts on the contest's subject. The questions are derived from industry sources, competitors, spectators and researchers based on a broad interpretation of the subject matter through a series of voting by the entire crowd. The combination of the questions from multi-facet sources and in different presentation modes aim to answer the same question and being rated by crowdsourcing techniques and protocols is unique for talent contests. It is the choosing of the questions and presentation modes of those questions that provides relevant and measurable answers.

The method 200 includes the following operations: soliciting basic questions from a database or additional sources to be voted on by various crowdsourcing techniques in order of perceived importance (operation 210); testing different presentation modes of questions to eliminate discrepancies and bias (operation 220); presenting three times the number of required questions with respective rankings, which are determined to be the most relevant, to the contest's task force for final selection (operation 230); permitting the contest's administrator to select the final questions in accordance with the contest's rubric (operation 240); presenting the questions as encoded to all WebNEVs in the manner selected by the administrator (operation 250); providing the outcomes in a number of formats to the task force on both a scheduled and on-demand basis (operation 260); performing on-going statistical evaluations to monitor for any anomalies in voting trends (operation 270); and using sentiment monitoring tools for comments and network buzz as a base evaluation against the voting results, monitoring and evaluating the level of congruency between feedback mediums with voting results of the method as both a means to monitor voting behavior and improve the questions and presentation methods (operation 280).

In operation 230, the possible questions may be directly created based on the event rubric without the need for additional inputs. Alternatively, the event creator/promoter may create and add additional or alternative questions. The protocol would scan for all potential questions and presentation methodology in the database and report them to the event administrator who would then make the final selection of questions and presentation mode with the event creator/promoter.

The creation of a pool of questions from multi-facet sources on a multitude of subjects and the development of different presentation mediums yields at least the following:

an ability to select questions congruent with the event's rubric;

an increase in the validity of the outcomes;

an ability to provide in-depth feedback to entrants;

an increase in the relevance between the event's rubric and the judging process; and

the maintenance of the predominance of merit, talent and/or skill over chance in determining the outcome.

A result of this operation is to further reduce bias, since questions and presentation mode can increase bias in numerous ways. For example, a WebNEV's vote is cumulative based on the answers to the questions by which the contestants' rankings are determined. The questions eliminate chance in decision-making and asking the right questions in the right manner is the best-known way to achieve the stated goal. Further, the best question and presentation mode selection provides increased transparency in the judging process to ensure that the contest is executed as promoted while creating specific and relevant feedback on the elements determining the winner(s).

In method 200, questions are derived from industry sources, competitors, spectators and researchers based on a broad interpretation of the subject matter. Then, the questions are ranked by crowdsourcing. The combination of the questions from multi-facet sources and in different presentation modes aim to answer the same question and being rated by crowdsourcing techniques and protocols is unique for merit, talent and/or skill events. It is the choosing of the questions and presentation modes of those questions that provides relevant and measurable answers.

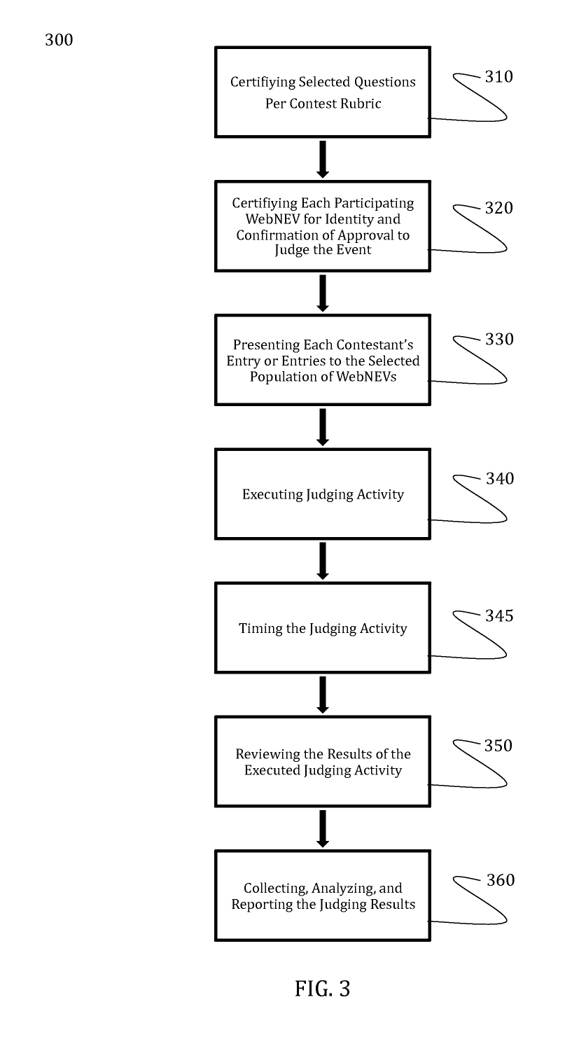

Referring now to FIG. 3, there is illustrated a method 300 of conducting a contest, competition, and/or event. In this method, generally, a judging arena is created, the contest is conducted by accumulating votes from a selected sub-population of WebNEVs; and the voting results are analyzed by applying specified contest metrics. The method 300 includes the following operations:

certifying selected questions to confirm that they are within the contest's judging rubric (operation 310);

certifying each participating WebNEV for identity and confirmation of approval to judge the event (operation 320);

presenting each contestant's entry or entries in a manner consistent with the contest's rubric to the selected population of WebNEVs (operation 330);

executing judging activity by asking of the certified WebNEV(s) a discrete series of questions pertaining to each entry requiring answers in different response modes to yield judging results (operation 340);

timing the judging activity to ensure that a specified elimination level requirement is satisfied (operation 345);

reviewing the judging results of the executed judging activity (operation 350); and

collecting, analyzing, and reporting the judging results (operation 360).

Optionally, the selected population of registered judges may be produced by method 100. Additionally and/or alternatively, the selected population may be produced by converting a plurality of judge candidates into a population of registered web based non-expert judges (WebNEVs) by establishing the unique identity of each WebNEV, which renders the WebNEV registered; assessing attributes of each registered WebNEV, the attributes being usable to determine which type of contest the WebNEV would be suitable to judge; and the degree of demographic diversity within the judging body; collecting and analyzing information about the reasons each registered WebNEV wants to judge the contest, the information being usable to determine whether the registered WebNEV could be a satisfactory judge for a contest; and selecting a sub-population of WebNEVs from the population of registered WebNEVs, the selected sub-population consisting of WebNEVs who, as a group, can best judge the contest's entries based on the contest rubric.

The method 300 may be implemented using proprietary or a combination of off-the-shelf software(s). This software may be centralized but operated from specifically designed computers assigned to individual WebNEVs. Additionally and/or alternatively, the software would be downloaded on any computing device that is designated to a WebNEV.

Method 300 provides transparency in the judging process to ensure that the contest is executed as promoted while creating specific feedback on the elements determining the winner(s).

In operation 310, all questions are presented to the WebNEVs in accordance with the event's rubric for each entry. Here, it is to be appreciated that in this operation a series of created questions are asked and answered, rather than only applying a rating system based on scale or a simple answer to only one question. It is the composite of answers to the questions that are at the heart of elevating the predominance of merit, talent and/or skill over chance. The questions may be designed to generate feedback to the contestant.

An objective of this operation is the integration of non-expert voting that reflects the mores of today's spectators while not disregarding the value of the expert opinion. Further, the best question and presentation mode selection provides increased transparency in the judging process to ensure that the event is executed as promoted while creating specific and relevant feedback on the elements determining the winner(s).

In operation 360, results of the voting are accumulated and analyzed. Here, a myriad of statistical testing may be used to understand both the statistical and practical significance of its outputs. Two examples of testing protocols are testing for statistical significance and measures of association. The combination of these tests gives us both the probability that relationships exist and the depth, even direction, of the relationship. Such tests constitute a common yardstick that can be understood by a great many people while communicating essential information These types of statistical testing, along with the employment of discerning algorithms, against statistical predictive behaviors of both the crowd and WebNEVs will increase the validity of JPINEV, as well as its transparency.

Analysis of the voting results may take many forms, and numerous forms are both possible and contemplated. For example, the results may be compared to identify anomalies for purposes of review and investigation of validity. Specifically, in the event of disputes, ties or unexpected anomalous outcomes between a viewer/popular vote versus the results of the WebNEVs votes, there will be a further review and adjudication by a celebrity judge who is recognized in the contest entry type's field as an expert and/or celebrity in conjunction with one or more randomly selected certified WebNEVs who had/have not previously voted in the contest. The results may also be: collated in order to provide the most detailed feedback of voter demographics and responses; and analyzed via specified methodologies, (e.g. crowd science, game theory, voting theory) to formulate future weighting and design criteria to increase the value and credibility of the judging process.

In operation 360, the analysis may be usable to identify anomalies concerning: WebNEV profiles, question rankings and relationships, and sentiment evaluation from spectator input(s).

In the absent of anomalies, the voting results are declared valid. In the presence of anomalies, the voting results may be reviewed by the contest/event's administration and the situation resolved according to the nature of the anomaly. For example, if the sentiment of the spectator population ranked one entry considerably higher than another, the reasons for this would be analyzed, which might trigger another round of voting or a dismissal of the anomaly due to this sentiment being contributed to the efforts by a parent of the entry. Further, these anomaly resolution activities are fed back into the two pools: the registered WebNEVs and the questions, in order to maintain diversity therein.

Additionally and/or alternatively, results of the analysis may be used, for example, to nominate the contestants who have been chosen to go to the next contest level or declared as winner(s), as well as to improve future contest voting tools and WebNEV selection.

The foregoing illustrates, aspects of the present invention provide a protocol for judging contest, competition, and/or event entries conducted on the Internet in either a Web 2.0 or better environment, a protocol to create and present questions to potential judges, and a protocol for conducting a contest, competition, and/or event. The approaches create and use a judging protocol of Internet non-expert voters (JPINEV) answering questions designed around the contest's stated rubric to achieve at least some of the following six outcomes in addition to the identification of winners:

1. elevate the predominance of merit, skill, talent over chance;

2. create a transparent judging process;

3. increase the trust factor of participants;

4. provide a detailed review of an entry by non-experts but representative of the end-user or consumer;

5. give discrete evaluation criteria; and

6. allow an option to charge entry fees and award cash prizes.

One significant aspect of the aforementioned methods is that WebNEVs:

1. may have their identity verified;

2. may be timed while performing their judging duties;

3. may be shown the content to be judged in a random manner that is consistent with the elements to be judged;

4. may answer more than one question in regard to the content; and

5. may be monitored in terms of response authenticity.

Another significant aspect of the aforementioned methods is that diversity in a judging pool, as well as the predominance of merit, talent and/or skill over chance, are ensured. In more detail, crowdsourcing judging, in which skill and/or talent and/or merit will predominate the voting outcomes rather than chance when using non-expert demographically diverse voters is employed. A result is that contests may be judged by a diverse group of judges rather than a homogenous group of judges evidenced by transparency and relevancy, which is not a hindrance to the taking of fees and the awarding of prizes. Thus, aspects of the present invention provide a means by which demographically diverse non-expert voters, without regard to numbers, can judge a contest without diluting the predominance of merit, talent and/or skill and equally important, while providing a judging method and system for functioning in a reputation economy.

Additionally, the methods described above may also be applied to non-virtual contests because of the selection of judges, the questions and the transparency. Still further, these approaches may also be used in an evaluating scenario of different products or media presentations without a prize being the goal.

Embodiments of the present invention may be embodied in a general purpose digital computer that is running a program from a tangible computer usable medium, including but not limited to, storage media such as magnetic storage media (e.g., ROM's, floppy disks, hard disks, etc.), and optically readable media (e.g., CD-ROMs, DVDs, etc.). Hence, the embodiment may be embodied as a computer usable medium having a computer readable program code unit embodied therein. A functional program, code and code segments, usable to implement embodiments of the present invention can be derived from the description of the invention contained herein. Also, various operations of the various methods of the present invention may be executed by specialized or general modules or by processors.

Embodiments of the present invention may be embodied in an apparatus adapted and configured to execute the various aspect thereof.

Although selected embodiments of the present invention have been shown and described individually, it is to be understood that at least aspects of the described embodiments may be combined.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

We claim:

1. A method of creating a diverse population of judges, comprising:
generating a population of potential web based non-expert judges (WebNEVs) by establishing the unique identity of each WebNEV, which creates a WebNEV application for the respective potential WebNEVs;
assessing attributes of each potential WebNEV, the attributes being usable (i) to determine which type of contest the WebNEV would be suitable to judge and (ii) to determine and/or increase the degree of demographic diversity within the judging body;
collecting and analyzing information about the reasons each potential WebNEV wants to judge the contest, the information being usable to determine whether the prospective WebNEV could be a satisfactory judge for a contest;
registering the accepted application as registered WebNEVs; and
selecting a sub-population of WebNEVs from the population of registered WebNEVs, the selected sub-population consisting of WebNEVs who, as a group, can best judge the contest's entries based on the design of the contest,
wherein at least one of the converting, assessing, collecting, and selecting is performed by a computer.

2. A contest, competition, or event judging method, comprising:
accepting applications from potential web based non-expert judges (WebNEV) by establishing the unique identity thereof to yield a population of potential WebNEVs;
assessing attributes of each potential WebNEV;
collecting and analyzing information about the reasons each potential WebNEV wants to judge the contest, competition, or event; and
selecting and registering WebNEVs from the population of potential WebNEVs, the selected WebNEVs being those that as a group which maximizes demographic diversity while balancing bias in accordance with the contest's, competition's, or event's rubric,
wherein at least one of the registering, assessing, collecting, and selecting is performed by a computer.

3. The method of claim 2, wherein, in the accepting, only a prospective WebNEV that visits a selected website, chooses to participate in deciding the contest outcome, and whose identity is confirmed by a third party may be registered.

4. The method of claim 2, wherein in the assessing, at least a personality test, a life knowledge/experience tests, or informational demographics is used, and
wherein information about the assessed attributes is amalgamated for in-depth profiling.

5. The method of claim 2, wherein reasons that each potential WebNEV wants to judge the contest are assessed,
wherein the reasons are collected through questionnaires and interviews, and
wherein responses to the questionnaires and interviews provide a relative scale of distinct compensation for each potential WebNEV.

6. The method of claim 2, wherein, in the selecting, a number of WebNEVs required for each round of the contest, may be based on rubrics of the contest.

7. The method of claim 2, wherein, in the selecting, WebNEVs are selected in a manner consistent with entry requirements and judging rules of the contest.

8. The method of claim 2, wherein, in the selecting, WebNEVs are selected based on a contest creator/promoter's answers to specific questions about the contest and descriptions of the qualities on which to base selection of the WebNEVs for the contest.

9. The method of claim 2, wherein, in the analyzing and outputting, voting results are compared to identify anomalies, and
wherein, when an anomaly is identified, there will be further adjudication by a judge who is recognized as an expert and/or celebrity and at least one selected registered WebNEV who has not previously voted in the contest.

10. The method of claim 2, wherein, in the analyzing and outputting, the results are:
collated in order to provide the most detailed feedback of voter demographics and responses; and
analyzed via at least one specified methodology to formulate future vote weighting and contest design criteria.

11. The method of claim 10, wherein the at least one methodology is crowd science, game theory, or voting theory.

12. A method of creating and presenting a diverse pool of questions and various modes of presentation for answering usable in the building of a pool of questions to be asked by those selected to judge a wide range of competitions, comprising:
soliciting basic questions from its own database or additional sources to be voted on by various crowdsourcing techniques in order of perceived importance;
testing different presentation mode of questions to eliminate discrepancies and bias;
presenting three times a number of required questions with respective rankings, which are determined to be most relevant, to a contest's task force for final selection;
permitting the contest's administrator to select final questions in accordance with the contest's rubric;
presenting the questions as encoded to all WebNEVs in the manner selected by the administrator;
providing the outcomes in a number of formats to the task force on both a scheduled and on-demand basis;
performing on-going statistical evaluations to monitor for any anomalies in voting trends; and
monitoring and evaluating, using sentiment monitoring tools for comments and network buzz as a base evaluation against the voting results, a level of congruency between feedback mediums with voting results of the method as both a means to monitor voting behavior and improve the questions and presentation methods,
wherein at least one of the soliciting, testing, presenting three time a number of required questions, permitting, presenting the questions, providing, performing, and monitoring is performed by a computer.

13. The method of claim 12, wherein, in the presenting three times a number of required questions with respective rankings, the required questions may meet all the requirements of the contest rubric.

14. The method of claim 12, wherein, in the presenting three times a number of required questions with respective rankings, a contest creator/promoter answers specific questions about the contest and states the qualities on which to base voting.

15. The method of claim 12, further comprising scanning for all potential questions and presentation methodology in the database and report them to the contest administrator who makes a final selection of questions and presentation mode with the contest creator/promoter.

16. A method of conducting a contest, competition, and/or event, comprising:
certifying selected questions to confirm that they are within the contest's/competition's/event's judging rubric;
certifying each participating registered web based non-expert judge (WebNEV) of a selected population of WebNEVs based on WebNEV identity and confirmation of approval to judge the contest/competition/event;
presenting each contestant's entry or entries in a manner consistent with the contest's rubric to the selected population of WebNEVs;
executing judging activity by asking of the certified WebNEV(s) a discrete series of questions pertaining to each entry requiring answers in different response modes to yield judging results;
timing the judging activity to ensure that a specified elimination level requirement is satisfied;
reviewing the judging results of the executed judging activity; and
collecting, analyzing, and reporting judging results.

17. The method of claim 16, wherein the selected population is produced by the method of claim 1.

18. The method of claim 16, wherein the selected population is produced by the method of claim 2.

19. The method of claim 16, wherein, in the presenting, all questions are presented to the WebNEVs in accordance with the event's rubric for each entry.

20. The method of claim 16, wherein, in the analyzing, results are compared to identify anomalies for purposes of review and investigation of validity.

21. The method of claim 16, in the collecting, results are: collated in order to provide the most detailed feedback of voter demographics and responses; and analyzed via specified methodologies, (e.g. crowd science, game theory, voting theory) to formulate future weighting and design criteria to increase the value and credibility of the judging process.

22. The method of claim 16, wherein results of the analyzing are usable to identify anomalies concerning: WebNEV profiles, question rankings and relationships, and sentiment evaluation from spectator(s) input(s).

23. The method of claim 22, wherein, when an anomaly is identified, voting results are reviewed by a contest/event's administration and resolved according to a nature of the anomaly.

24. The method of claim 16, wherein results of the analysis are used to nominate the contestants who have been chosen to go to the next contest level or are declared as winner(s), as well as to improve future contest voting tools and WebNEV selection.

25. A tangible computer-readable storage medium encoded with processing instructions for causing a processor to execute the method of claim 1.

26. A tangible computer-readable storage medium encoded with processing instructions for causing a processor to execute the method of claim 2.

27. A tangible computer-readable storage medium encoded with processing instructions for causing a processor to execute the method of claim 12.

28. A tangible computer-readable storage medium encoded with processing instructions for causing a processor to execute the method of claim 16.
